(19) United States
(12) Patent Application Publication
(10) Pub. No.: US 2005/0258802 A1
(43) Pub. Date: Nov. 24, 2005

(54) Battery fluid dispenser integrated into battery charging connector

(75) Inventors: Blake E. Dickinson, Monrovia, CA (US); William D. Buchanan, Covina, CA (US)

Correspondence Address: Robert E. Krebs;Thelen Reid & Priest LLP, P.O. Box 640640, San Jose, CA, 95164-0640, US

(73) Assignee: Aerovironment, Inc., a California Corporation

(21) Appl. No.: 10/848,872

(22) Filed: May 18, 2004

(51) Int. Cl. H02J 7/00

(52) U.S. Cl. 320/112

(57) ABSTRACT

A watering connection is integrated with a battery charging connector to form an integrated charging and watering connector. The integrated charging and watering connector selectively couples fluid from a fluid supply and a charging voltage from a battery charger to one or more batteries of a battery pack. At an appropriate time, such as after charging or equalization of the batteries of the battery pack, the charger transmits a control signal to a fluid supply control valve. The control signal opens the control valve, thereby allowing cells of the batteries of the battery pack to be replenished. Check valves coupled to the cells of the batteries of the battery pack can be used to halt the filling of cells. Alternatively, a fluid level detector monitors the fluid level in the cells. If not adequately filled, the fluid level detector transmits a sense signal back to the charger. The charger then issues a control signal to open the fluid supply control valve. Fluid is then allowed to fill the cells until the fluid level detector determines that the cells are adequately filled.

### FIELD OF THE INVENTION

The present invention relates to the maintenance of wet cell batteries. More particularly, the present invention relates to methods and apparatus for overcoming negligent maintenance of wet cell batteries.

### BACKGROUND OF THE INVENTION

Rechargeable wet cell batteries are commonly used, among other applications, to power industrial vehicles such as forklifts and airport ground support vehicles. Proper maintenance of such batteries requires periodic charging as well as monitoring of electrolyte levels in the batteries. To charge the batteries, a person responsible for maintaining the batteries connects the terminals of the batteries to the terminals of a charger, typically via an electrical connector that connects cables from the battery terminals to cables from the charger. To replenish the electrolyte the maintenance person typically adds water to the cells of the battery using a hose connected to a water supply.

While a properly trained, careful and diligent maintenance person will ideally charge the batteries when they need charging and water the batteries when they need watering, in practice this is not the case. In fact, often times the maintenance person either forgets or lacks the proper training necessary to charge and/or water the batteries. Failing to water the batteries is particularly problematic since it can lead to a reduction in battery life and may even lead to irreversible harm to the batteries. Other times the maintenance person waters the batteries before necessary. Premature watering is undesirable since it can cause electrolyte to overflow from the battery cells, thereby compromising the health and safety of the maintenance person or others. Overflowing can also be harmful to the environment since the electrolyte contains toxic chemicals such as sulfuric acid.

What are needed, therefore, are systems and methods for quickly and efficiently charging and watering batteries, and which avoid problems caused by unskilled, forgetful, and/or mistaken maintenance persons.

### SUMMARY OF THE INVENTION

Methods and apparatuses for charging and watering (i.e. dispensing battery fluids to) wet cell batteries using an integrated charging and watering connector are disclosed. According to an embodiment of the invention, the connector comprises a first half and a second half. The first half includes a fluid inlet port and an electrical input port. The second half includes a fluid outlet port and an electrical output port. When the first and second halves of the connector are connected, the fluid inlet port of the first half is configured to receive fluid and direct the received fluid to the fluid outlet port of the second half, and the electrical input port is in electrical contact with the electrical output port.

According to another embodiment of the invention, a method of charging and dispensing fluids to cells of batteries of a battery pack is disclosed. According to the method, electrical terminals of one or more batteries are electrically coupled to a first electrical port of a first half of an integrated charging and fluid dispensing connector. A fluid distribution section is coupled between a fluid inlet port of said one or more batteries and a fluid outlet port of the first half of the connector. When the first half of the connector is connected to a first half of the connector, the fluid outlet port of the first half of the connector is coupled to a fluid inlet port of the second half of the connector, and a second electrical port of the second half of the connector is in electrical contact with the first electrical port of the first half of the connector.

According to yet another embodiment of the invention, an integrated battery charging and fluid distribution system is disclosed. The system comprises a battery charger, one or more batteries, and an integrated charging and fluid dispensing connector. The connector includes a first half and a second half, the first half having an electrical distribution port electrically coupled to the battery charger and a fluid inlet port configured to selectively receive fluid from a fluid supply. The connector also includes a second half having an electrical receiving port electrically coupled to terminals of the one or more batteries and a fluid outlet port configured to selectively distribute fluids to cells of the one or more batteries.

Other aspects of the inventions are described and claimed below, and a further understanding of the nature and advantages of the inventions may be realized by reference to the remaining portions of the specification and the attached drawing.

### BRIEF DESCRIPTION OF THE DRAWINGS

FIG. 1 shows an integrated charging and watering connector and associated system, according to embodiments of the present invention.

### DETAILED DESCRIPTION

Embodiments of the present invention are described herein in the context of wet battery cell charging and battery fluid replenishing methods, apparatuses and systems that overcome the negligent maintenance of wet cell batteries. Those of ordinary skill in the art will realize that the following detailed description of the present invention is illustrative only and is not intended to be in any way limiting. For example, the term “watering” is used in a broad sense throughout the detailed description to mean replenishing not only the “water” of the battery cells but adding any other appropriate fluid to the battery cells, including, for example, tap water, purified water, distilled water, deionized water, acid, electrolyte, etc. Accordingly, other embodiments of the present invention will readily suggest themselves to such skilled persons having the benefit of this disclosure.

Reference will now be made in detail to implementations of the present invention as illustrated in the accompanying drawings. The same reference indicators will be used throughout the drawings and the following detailed description to refer to the same or similar parts.

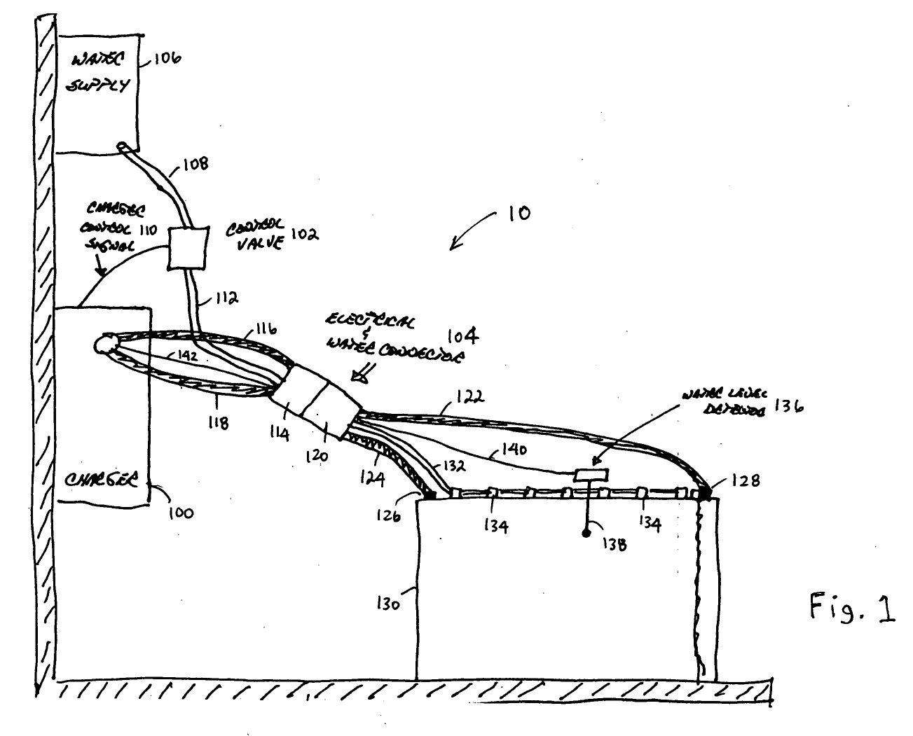

Referring first to FIG. 1, there is shown an integrated battery charging and watering system 10, according to an embodiment of the present invention. The system 10 comprises a charger 100, a fluid supply control valve 102, an integrated electrical/fluid connector 104, and a fluid supply 106. A first fluid distribution section (e.g. a hose) 108 receives fluid from the fluid supply 106 and distributes the fluid to a fluid inlet port of the fluid supply control valve 102.

The fluid supply control valve 102 comprises an electrically controlled valve (e.g. a solenoid valve), the opening and closing of which is controlled by a control signal transmitted from the charger 100 to the fluid supply control valve 102 over a control signal line 110. When the control signal has a value that causes the fluid supply control valve 102 to open, a second fluid distribution section 112 is configured to receive fluid from an outlet port of the fluid supply control valve 102. The received fluid is distributed to a fluid inlet port of a first half 114 of the electrical/fluid connector 104. Conversely, when the control signal has a value that causes the fluid supply control valve 102 to close, distribution of fluid from the fluid distribution port of the fluid supply control valve 102 to the fluid inlet port of the first half 114 of the electrical/fluid connector 104 is blocked.

The first half 114 of the electrical/fluid connector 104 also contains an electrical input port that is configured to receive electrical cables 116 and 118 from power supply terminals of the charger 100.

A second half 120 of the electrical/fluid connector 104 has a fluid outlet port that is coupled to the fluid inlet port of the first half 114 of the connector 104, when the first and second halves 114 and 120 of the connector 104 are connected. The second half 120 of the electrical/fluid connector 104 also contains an electrical output port. When the first and second halves 114 and 120 of the electrical/fluid connector 104 are connected, the electrical receiving port of the second half 120 makes electrical contact with the electrical distribution port of the first half 114.

Electrical cables 122 and 124 are coupled between the electrical output port of the second half 120 of the connector 104 and battery terminals 126 and 128 of a battery or plurality of electrically coupled batteries (i.e. battery pack) 130. A third fluid distribution section 132 is coupled between one or more watering inlets of the battery pack 130 and the fluid outlet port of the second half 120 of the electrical/fluid connector 104. Preferably, the watering inlet of the battery pack 130 comprises a single-port watering system. The single port watering system includes a manifold which allows all or substantially all cells of the battery or battery pack 130 to be watered at the same time through a single access port (i.e. watering inlet) of the manifold. Each of the cells of the batteries of the battery pack 130 may also include a check valve 134 (e.g. using a float) to regulate whether fluid can be added to the cell.

A fluid level detector 136 having an electrolyte sensor 138 is configured to monitor the fluid level in the cells of the batteries of the battery pack 130. A sense signal indicating whether the fluid is low or sufficiently filled is transmitted back to the charger 100 via a sense lines 140 and 142, which are either routed through the electrical/fluid connector 104, as shown in FIG. 1, or routed to the charger 100 independent of the connector 104. The sense signal is used by the charger 100 to determine whether the control signal on control signal line 110 should have a value that opens the fluid supply control valve 102 or closes the control valve 102.

Although not shown in the drawing, the fluid inlet port of the first half 114 of the electrical/fluid connector 104 and/or the fluid outlet port of the second half 120 of the electrical/fluid connector 104 may contain check valves, to prevent fluid remaining in the second and third fluid distribution sections 112 and 132 from leaking out of the fluid ports of the connector 104 in the event that the fluid supply control valve 102 fails or when the first and second halves 114 and 120 of the connector 104 are not mated.

According to an embodiment of the present invention, watering the batteries of the battery pack 130 may be controlled according to an “open loop” operation or, alternatively, according to a “closed loop” operation. In either operation, watering of the battery pack 130 may be performed following a full charging or equalization operation of the batteries of the battery pack 130. Full charging and equalization operations cause the fluid levels in the cells of the batteries of the battery pack 130 to rise. Accordingly, by postponing watering until after a full charging operation or equalization operation, the possibility of over-watering the cells of the batteries of the battery pack 130 can be avoided.

Alternatively, watering can occur at other times other than following a full charge or equalization operation. For example, using the connector 104 watering the batteries of the battery pack 130 may be performed after a predetermined duration of the equalization process (e.g. midway through the process). According to this alternative embodiment, the remainder (or a portion of the remainder) of the equalization process can be used to mix the added fluid into the electrolyte using the bubbling action observed when the battery is entering or within an overcharging state.

According to the open loop mode of operation, the batteries of the battery pack 130 are watered, following a charging or equalization process, which may be scheduled in accordance with a periodic time table (e.g. once a week). Charging, equalization and watering can all be performed using the same integrated electrical/fluid connector 104. After a charging or equalization process of the battery pack 130 has been completed, the charger 100 transmits a control signal, via control signal line 110, to cause the fluid supply control valve 102 to open. Once opened, fluid is allowed to flow from the fluid supply 106, through the first fluid distribution section 108, control valve 102, second fluid distribution section 112, electrical/fluid connector 104, third fluid distribution section 132, and manifold of the single port watering system, thereby replenishing the fluid in the cells of the batteries of the battery pack 130. Fluid is added until the check valves 134 close and prevent more fluid from being added. It should be mentioned here that, whereas watering according to this open loop mode preferably follows a charging or equalization of the battery pack 130, those of ordinary skill in the art will readily understand and appreciate that the watering step can be performed at other times, and does not necessarily need to follow a full charging or equalization process.

According to the closed loop mode of operation, the electrolyte sensor 138 of the fluid level detector 136 is used to determine the fluid level in the cells of the batteries of the battery pack 130. A sense signal indicating that the fluid levels are adequate or need to be replenished is sent back to the charger 100, via sense lines 140 and 142. If sufficiently full, there is no need to add fluid and the control signal from the charger 100 to the fluid supply control valve 102 (via the control signal line 110) has a value that maintains the control valve 102 in a closed position. On the other hand, if the electrolyte sensor 138 of the fluid level detector 136 detects that the fluid level is low, a sense signal indicating that the level is low is transmitted to the charger 100, via sense lines 140 and 142. Under such conditions, the charger 100 responds to the sense signal and transmits a control signal to the fluid supply control valve 102, via control signal line 110, causing the fluid supply control valve 102 to open, thereby allowing fluid to be added to the cells of the batteries of the battery pack 130. While fluid is being added to the cells the electrolyte sensor 138 of the fluid level detector 136 monitors the fluid levels in the cells. Once the fluid in the cells reaches a proper predetermined level, the fluid level detector 136 transmits a signal back to the charger 130, via sense lines 140 and 142, indicating that the cells are now properly filled. The charger 100, in turn, transmits a signal to the fluid control valve 102, via the control signal line 100, to cause the fluid supply control valve 102 to close.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope all such changes and modifications as are within the true spirit and scope of this invention.

1. An integrated electrical and watering connector for use in a battery charging and watering system, comprising:
a first half having a fluid inlet port and an electrical input port; and
a second half having a fluid outlet port and an electrical output port, wherein, when the first and second halves are connected, the fluid inlet port of the first half is configured to receive fluid and direct the received fluid to the fluid outlet port of the second half, and the electrical input port is in electrical contact with the electrical output port.

2. The integrated electrical and watering connector of claim 1 wherein the fluid outlet port of the second half of the connector is configured so that it can be coupled to a fluid receiving port of a fluid distribution system of one or more batteries, and the electrical output port is configured so that it can be electrically coupled to electrical terminals of the one or more batteries.

3. The integrated electrical and watering connector of claim 2 wherein the fluid inlet port is configured so that it can selectively receive fluid for replenishing fluid in cells of the one or more batteries.

4. The integrated electrical and watering connector of claim 3 wherein the electrical input and output ports, when in electrical contact with one another, are configured so that a charging voltage can be selectively coupled to the electrical terminals of the one or more batteries.

5. The integrated electrical and watering connector of claim 1, further comprising a check valve coupled to the fluid inlet port.

6. The integrated electrical and watering connector of claim 1, further comprising a check valve coupled to the fluid outlet port.

7. The integrated electrical and watering connector of claim 1 wherein said fluid is a fluid selected from the group consisting of water, tap water, purified water, distilled water, deionized water, acid and electrolyte.

8. A method of charging and watering one or more batteries, comprising:
electrically coupling electrical terminals of one or more batteries to a first electrical port of a first half of an integrated charging and watering connector;
coupling a fluid distribution section between a fluid inlet port of said one or more batteries and a fluid outlet port of the first half of the connector;
connecting a second half of the connector to the first half of the connector so that, when connected, the fluid outlet port of the first half is coupled to a fluid inlet port of the second half, and a second electrical port of the second half is in electrical contact with the first electrical port of the first half.

9. The method of claim 8, further comprising applying a charging voltage to the second electrical port of the second half of the connector so that the charging voltage is coupled through the connector to the terminals of said one or more batteries.

10. The method of claim 9, further comprising applying the charging voltage to equalize cells of the one or more batteries.

11. The method of claim 8, further comprising:
selectively allowing fluid to enter the fluid inlet port of the second half of the connector; and
directing the fluid entering the fluid inlet port through the fluid outlet port of the second half of the connector and into cells of the one or more batteries.

12. The method of claim 11 wherein selectively allowing fluid to enter the fluid inlet port of the second half of the connector depends on whether a fluid supply control valve coupled to the fluid inlet port is open or closed.

13. The method of claim 12, further comprising measuring the fluid level of cells of the one or more batteries.

14. The method of claim 13, further comprising generating a fluid level sense signal indicative of the fluid level of cells of the one or more batteries.

15. The method of claim 14 wherein a value of the fluid level sense signal is used to determine whether the fluid supply control valve is open or closed.

16. The method of claim 10, further comprising:
selectively allowing fluid to enter the fluid inlet port of the second half of the connector; and
directing the fluid entering the fluid inlet port through the fluid outlet port of the first half of the connector and into cells of the one or more batteries.

17. The method of claim 16 wherein selectively allowing fluid to enter the fluid inlet port of the second half of the connector depends on whether a fluid supply control valve coupled to the fluid inlet port of the second half of the connector is open or closed.

18. The method of claim 8 wherein said fluid is a fluid selected from the group consisting of water, tap water, purified water, distilled water, deionized water, acid and electrolyte.

19. The method of claim 8, further comprising allowing fluid to be dispensed into cells of said one or more batteries.

20. The method of claim 19 wherein allowing fluid to be dispensed is performed after said one or more batteries is fully charged and/or equalized.

21. The method of claim 19 wherein allowing fluid to be dispensed is performed after a predetermined portion of a charging or equalization cycle.

22. An integrated battery charging and watering system, comprising:
a battery charger;
one or more batteries; and
a connector including a first half and a second half, the first half having an electrical distribution port electrically coupled to the battery charger and a fluid inlet port configured to selectively receive fluid from a fluid supply, and the second half having an electrical receiving port electrically coupled to terminals of the one or more batteries and a fluid outlet port configured to selectively distribute fluid to cells of the one or more batteries.

23. The integrated battery charging and watering system of claim 22, further comprising a fluid supply control valve coupled between the fluid supply and the fluid inlet port of the first half of the connector.

24. The integrated battery charging and watering system of claim 23, further comprising a fluid level detector configured to sense the fluid level in the cells of the one or more batteries.

25. The integrated battery charging and watering system of claim 24, further comprising:
a first sense line coupled between a sense output of the fluid level detector and the second half of the connector; and
a second sense line coupled between the first half of the connector and the charger,
wherein when the first and second sense lines are electrically coupled to one another when the first and second halves of the connector are connected.

26. The integrated battery charging and watering system of claim 25, further comprising a control signal line coupled between the charger and a control input of the fluid supply control valve.

27. The integrated battery charging and watering system of claim 26 wherein a value of the control signal transmitted to the control input determines whether the fluid supply control valve is open or closed.

28. The integrated battery charging and watering system of claim 27 wherein the value of the control signal depends on a sense received from the fluid level detector.

29. The integrated battery charging and watering system of claim 22 wherein said fluid selected from the group consisting of water, tap water, purified water, distilled water, deionized water, acid and electrolyte.
